(19) United States
(12) Patent Application Publication
(10) Pub. No.: US 2019/0252795 A1
(43) Pub. Date: Aug. 15, 2019

(54) ANTENNA DEVICE

(71) Applicant: Panasonic Corporation, Osaka (JP)

(72) Inventors: TOMOHIRO MURATA, Kanagawa (JP); JUNJI SATO, Tokyo (JP)

(21) Appl. No.: 16/270,940

(22) Filed: Feb. 8, 2019

(30) Foreign Application Priority Data
Feb. 15, 2018 (JP) 2018-025032

(51) Int. Cl. H01Q 21/00; H01Q 1/52

(52) U.S. Cl. CPC H01Q 21/0025; H01Q 5/30; H01Q 1/523

(57) ABSTRACT

An antenna device includes: a first sub-array antenna provided on a substrate and having a group of first antenna elements, one or more third antenna elements, and a first electrical power line through which electric power is supplied to the group of first antenna elements and the one or more third antenna elements; and a second sub-array antenna provided on the substrate and having a group of second antenna elements, the one or more third antenna elements, and a second electrical power line through which electric power is supplied to the group of second antenna elements and the one or more third antenna elements. The one or more third antenna elements are placed away from the first electrical power line and the second electrical power line.

### BACKGROUND

### 1. Technical Field

The present disclosure relates to antenna devices.

### 2. Description of the Related Art

In wireless communication, a multiple-input multiple-output (MIMO) system having a plurality of transmitters (transmission antennas) and a plurality of receivers (reception antennas) has been known as a method for improving the communication speed and/or reliability. For example, applying the MIMO system to a radar system can improve the performance of target detection.

The radar to which the MIMO system is applied has a virtual array antenna having M×N elements (this antenna may hereinafter be referred to as a “virtual antenna array”), where M indicates the number of transmission antennas, and N indicates the number of reception antennas. In order to enhance the directional gain of each antenna, a sub-array antenna configuration having a plurality of antenna elements is used for the antenna.

For example, Japanese Unexamined Patent Application Publication (Translation of PCT Application) No. 2011-526370 (hereinafter referred to as “Patent Document 1”) discloses an antenna device for a two-dimensional MIMO radar, the antenna device using the sub-array antenna configuration. According to Patent Document 1, in the antenna device, when four reception sub-array antennas are aligned with each other with an antenna gap d that is equivalent to a half of a signal wavelength, and two transmission sub-array antennas are aligned with each other with an antenna gap 4d, an aperture area corresponding to eight antennas can be obtained.

It is also known that grating lobes, which cause erroneous radar detection, do not occur when the antenna gap is set to a gap that is equivalent to a half of the signal wavelength, but can occur when the antenna gap is larger than a half of the signal wavelength.

### SUMMARY

In the above-described related art in Patent Document 1, however, when a virtual antenna array is constructed with an antenna gap with which no grating lobes do not occur, there are cases in which it is difficult to increase the number of antenna elements in relationship to a mounting area in actual array arrangement. Thus, it has been difficult to realize an improvement in antenna performance, for example, an improvement in the directional gain or suppression or reduction of unwanted sidelobes.

One non-limiting and exemplary embodiment provides an antenna device that can realize an improvement in the antenna performance by increasing the number of antenna elements in each sub-array antenna without changing the antenna gap.

In one general aspect, the techniques disclosed here feature an antenna device that includes: a first sub-array antenna provided on a substrate and having a group of first antenna elements, one or more third antenna elements, and a first electrical power line through which electric power is supplied to the group of first antenna elements and the one or more third antenna elements; and a second sub-array antenna provided on the substrate and having a group of second antenna elements, the one or more third antenna elements, and a second electrical power line through which electric power is supplied to the group of second antenna elements and the one or more third antenna elements. The one or more third antenna elements are placed away from the first electrical power line and the second electrical power line.

One aspect of the present disclosure realizes an improvement in the antenna performance by increasing the number of antenna elements in each sub-array antenna without changing the antenna gap.

It should be noted that general or specific embodiments may be implemented as a system, an apparatus, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a top view illustrating one example of the configuration of an antenna device;

FIG. 1B is a sectional view of the antenna device illustrated in FIG. 1A;

FIG. 2A is a top view illustrating one example of the configuration of an antenna device according to a first embodiment of the present disclosure;

FIG. 2B is a sectional view of the antenna device illustrated in FIG. 2A;

FIG. 2C is an enlarged view illustrating an antenna element in FIG. 2A;

FIG. 3 is a graph illustrating a radiation characteristic of the antenna device according to the first embodiment of the present disclosure;

FIG. 4 is a top view illustrating a first modification of the configuration of the antenna device according to the first embodiment of the present disclosure;

FIG. 5 is a top view illustrating a second modification of the configuration of the antenna device according to the first embodiment of the present disclosure;

FIG. 6 is a top view illustrating one example of the configuration of an antenna device according to a second embodiment;

FIG. 7A is a top view illustrating a first modification of the antenna device according to the second embodiment of the present disclosure;

FIG. 7B is a top view illustrating a second modification of the antenna device according to the second embodiment of the present disclosure;

FIG. 7C is a top view illustrating a third modification of the antenna device according to the second embodiment of the present disclosure;

FIG. 8 is a top view illustrating one example of the configuration of an antenna device according to a third embodiment of the present disclosure; and

FIG. 9 is a top view illustrating another example of the configuration of the antenna device according to the third embodiment of the present disclosure.

### DETAILED DESCRIPTION

Embodiments of the present disclosure will be described below in detail with reference to the accompanying drawings. The embodiments described below are examples, and it is to be understood that the present disclosure is not limited by the embodiments.

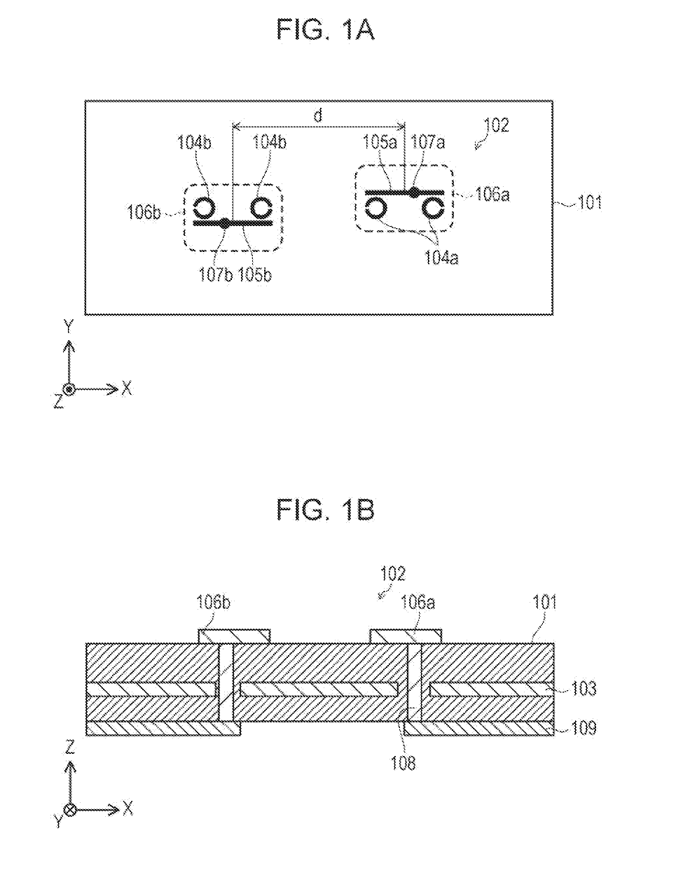

FIG. 1A is a top view illustrating one example of the configuration of an antenna device 102. FIG. B is a sectional view of the antenna device 102 illustrated in FIG. 1A. FIGS. 1A and 1B illustrate an X-axis, a Y-axis, and a Z-axis, for convenience of description.

The antenna device 102 radiates electromagnetic waves in a positive Z-axis direction. The antenna device 102 has, for example, sub-array antennas 106a and 106b.

The sub-array antennas 106a and 106b are formed, for example, on a dielectric substrate 101. The sub-array antennas 106a and 106b are formed of, for example, metal conductors.

The sub-array antenna 106a has, for example, a power supply line 105a that receives electric power at a power supply point 107a and two antenna elements 104a that receive electric power from the power supply line 105a.

The sub-array antenna 106b has, for example, a power supply line 105b that receives electric power at a power supply point 107b and two antenna elements 104b that receive electric power from the power supply line 105b.

A middle of the two antenna elements 104a in the sub-array antenna 106a or a middle of the power supply line 105a may be referred to as a “center of the sub-array antenna 106a”. A middle of the two antenna elements 104b in the sub-array antenna 106b or a middle of the power supply line 105b may be referred to as a “center of the sub-array antenna 106b”. The distance between the center of the sub-array antenna 106a and the center of the sub-array antenna 106b in an X-axis direction is defined as an antenna gap d between the sub-array antennas 106a and 106b.

Electric power is supplied to the sub-array antennas 106a and 106b through back-side wiring lines 109 and power supply vias 108. Supply of electric power may be referred to as “power supply”, as appropriate. Although, in this embodiment, each of the power supply points 107a and 107b and the center of the corresponding antenna elements 104a or 104b do not match each other, they may match each other depending on a system to be implemented.

For example, reflectors 103 are formed in a layer in the dielectric substrate 101. The reflectors 103 are formed as a metal layer in the dielectric substrate 101 by using a metal conductor. The reflectors 103 reflect electromagnetic waves that the sub-array antennas 106a and 106b radiate in a negative Z-axis direction. The reflectors 103 may also be referred to as a “reflective layer” or “reflection portions”.

Increasing the number of antenna elements in the antenna device 102 is conceivable in order to improve an antenna radiation gain (hereinafter may be referred to as an “antenna gain”). For example, an antenna element may be added to the antenna elements 104a at a position about one wavelength away in each of a positive X-axis direction and a negative X-axis direction. An antenna element may also be added to the antenna elements 104b at a position about one wavelength away in each of the positive X-axis direction and the negative X-axis direction.

However, when an attempt is made to maintain the antenna gap d, a space where additional antenna elements can be arranged becomes insufficient between the sub-array antennas 106a and 106b. When it is difficult to add an antenna element because of insufficient space, for example, it is difficult to expect an improvement in antenna performance, such as an improvement in a directional gain of the antenna device 102 or suppression or reduction of unwanted sidelobes.

The antenna device 102 is a two-dimensional MIMO radar in which the sub-array antennas 106a and 106b are arranged in a horizontal direction (the X-axis direction). For example, in the case of a three-dimensional MIMO radar in which sub-array antennas are arranged in both the horizontal direction and a vertical direction (a Y-axis direction), a space in which additional antenna elements are arranged becomes insufficient in one of or both the horizontal direction and the vertical direction. When the space insufficiency makes it difficult to add antenna elements, it is more difficult to improve the antenna performance.

The present disclosure has been made in view of the foregoing situation and provides an antenna device that can improve the antenna performance by increasing the number of antenna elements in each sub-array antenna without changing the antenna gap.

### FIRST EMBODIMENT

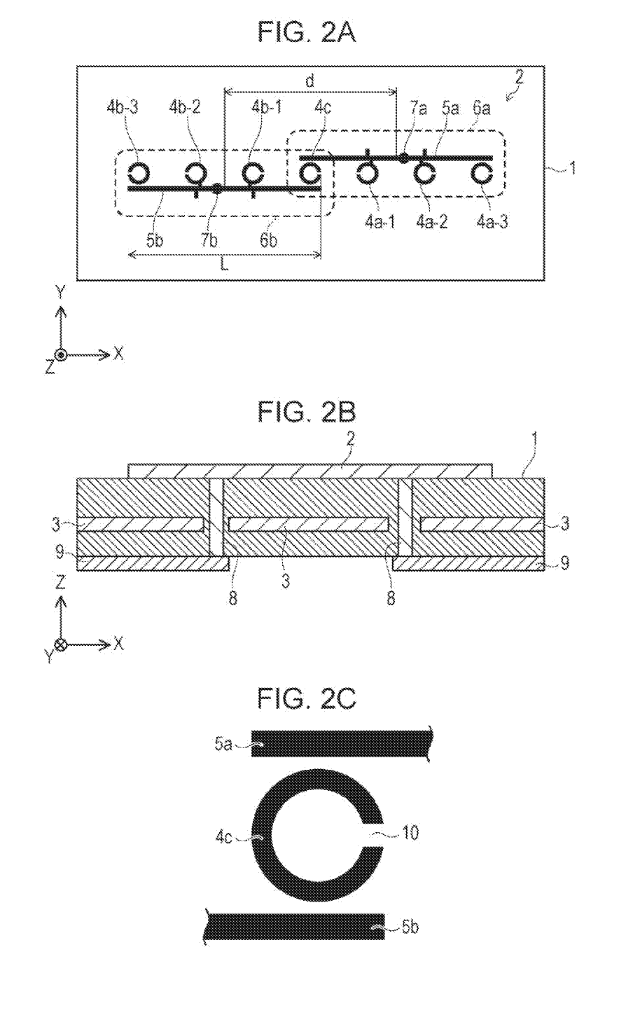

FIG. 2A is a top view illustrating one example of the configuration of an antenna device 2 according to the present embodiment. FIG. 2B is a sectional view of the antenna device 2 illustrated in FIG. 2A. FIG. 2C is an enlarged view illustrating an antenna element 4c in FIG. 2A. FIG. 2A illustrates an antenna pattern of the antenna device 2.

FIGS. 2A and 2B illustrate an X-axis, a Y-axis, and a Z-axis, for convenience of description. The X-axis, the Y-axis, and the Z-axis are also illustrated in some drawings described below, as appropriate.

The antenna device 2 is formed on a dielectric substrate 1, for example, by using a metal conductor. Reflectors 3 are formed at positions that are located in a metal conductor layer in the dielectric substrate 1 and that oppose the antenna device 2. A gap between the reflectors 3 and the antenna device 2 is adjusted so that, for example, electromagnetic waves radiated in the positive Z-axis direction, which is a radiation direction of the antenna device 2, and components in the radiation direction of electromagnetic waves radiated in the negative Z-axis direction and reflected by the reflectors 3 strengthen each other. The reflectors 3 may also be referred to as a “reflective layer” or “reflective portions”.

The antenna device 2 receives electric power from, for example, back-side wiring lines 9 through power supply vias 8. The power supply vias 8 supply electric power to, for example, a power supply point 7a of a power supply line 5a and a power supply point 7b of a power supply line 5b.

The antenna device 2 includes, for example, sub-array antennas 6a and 6b. The sub-array antenna 6a includes, for example, antenna elements 4a-1 to 4a-3 and 4c and the power supply line 5a. The sub-array antenna 6b includes, for example, antenna elements 4b-1 to 4b-3, the antenna element 4c, and the power supply line 5b. The antenna element 4c is shared by the sub-array antennas 6a and 6b.

In the description below, the sub-array antennas 6a and 6b may also be referred to as “sub-array antennas 6”, as appropriate. The antenna elements 4a-1 to 4a-3, 4b-1 to 4b-3, and 4c may also be referred to as “antenna elements 4”, as appropriate.

Since the sub-array antennas 6a and 6b function as a time-division MIMO antenna, electric powers are supplied from the power supply points 7a and 7b at different timings (in a time-division manner), rather than being supplied therefrom at the same time.

In the sub-array antenna 6a, the gap between the antenna element 4c and the antenna element 4a-1 and the gap between the antenna element 4a-2 and the antenna element 4a-3 are equal to each other. Thus, the center of the sub-array antenna 6a may be a middle of the antenna elements 4a-1 and 4a-2 in the sub-array antenna 6a or a middle of the power supply line 5a.

Also, in the sub-array antenna 6b, the gap between the antenna elements 4c and 4b-1 and the gap between the antenna elements 4b-2 and 4b-3 are equal to each other. Thus, the center of the sub-array antenna 6b may be a middle of the antenna elements 4b-1 and 4b-2 in the sub-array antenna 6b or a middle of the power supply line 5b.

The distance between the center of the sub-array antenna 6a and the center of the sub-array antenna 6b in the X-axis direction is defined as an antenna gap d between the sub-array antennas 6a and 6b.

The antenna gap d is, for example, smaller than L, where L indicates the size (the length L in the X-axis direction) of each of the sub-array antennas 6a and 6b. The position of the “power supply point” set on each “power supply line” and the center position of the “power supply line” do not necessarily match each other. Each “power supply point” is set, for example, at a position at which electrical currents having the same phase are supplied to the “antenna elements” arranged along the corresponding “power supply line”. Matters related to positional settings of the “power supply points” are not limited to those illustrated in FIG. 2A and also apply to other drawings that are referred to herein.

The power supply line 5a is arranged, for example, on the dielectric substrate 1 along the X-axis. The power supply line 5a receives electric power at the power supply point 7a. The power supply line 5b is arranged, for example, on the dielectric substrate 1 along the X-axis. The power supply line 5b receives electric power at the power supply point 7b.

Each of the antenna elements 4a-1 to 4a-3, 4b-1 to 4b-3, and 4c is a looped shape (which may also be referred to as a “circular-ring shape” or “doughnut shape”) element having a notch 10. The orientation of the notch 10 in each of the antenna elements 4a-2, 4a-3, 4b-1, and 4c is, for example, the positive X-axis direction. The orientation of the notch 10 in each of the antenna elements 4a-1, 4b-2, and 4b-3 is, for example, the negative X-axis direction. The orientations of the notches 10 in the antenna device 2 are merely exemplary, and the present disclosure is not limited thereto. For example, the orientations of the notches 10 may be set according to antenna characteristics.

The antenna elements 4a-1 to 4a-3 are arranged, for example, along the power supply line 5a. Of the antenna elements 4a-1 to 4a-3, the antenna elements 4a-1 and 4a-2 arranged at positions relatively close to the power supply point 7a are connected, for example, to the power supply line 5a via a metal conductor pattern to receive electric power from the power supply line 5a. Of the antenna elements 4a-1 to 4a-3, the antenna element 4a-3 arranged at a position relatively far from the power supply point 7a is, for example, not connected to the power supply line 5a via a metal conductor pattern and couples with the power supply line 5a via an electromagnetic field (i.e., performs electromagnetic-field coupling) to receive electric power from the power supply line 5a. This makes it possible to adjust electric power to be supplied to each antenna element 4.

The antenna elements 4b-1 to 4b-3 are arranged, for example, along the power supply line 5b. Of the antenna elements 4b-1 to 4b-3, the antenna elements 4b-1 and 4b-2 arranged at positions relatively close to the power supply point 7b are connected to, for example, the power supply line 5b via a metal conductor pattern to receive electric power from the power supply line 5b. Of the antenna elements 4b-1 to 4b-3, the antenna element 4b-3 arranged at a position relatively far from the power supply point 7b is, for example, not connected to the power supply line 5b via a metal conductor pattern and couples with the power supply line 5b via an electromagnetic field to receive electric power from the power supply line 5b. This makes it possible to adjust electric power to be supplied to each antenna element 4.

The antenna element 4c is arranged, for example, along the power supply lines 5a and 5b and between the antenna elements 4a-1 and 4b-1. The antenna element 4c couples, for example, with the power supply line 5a via an electromagnetic field to receive electric power from the power supply line 5a. Also, the antenna element 4c couples with the power supply line 5b, for example, via an electromagnetic field to receive electric power from the power supply line 5b. However, the antenna element 4c does not receive electric power from both the power supply lines 5a and 5b at the same timing. The antenna element 4c is not connected to the power supply lines 5a and 5b via a metal conductor pattern. The antenna element 4c is placed away from the power supply lines 5a and 5b.

The antenna elements 4a-1 and 4a-2 physically contact the power supply line 5a via a metal conductor pattern in order to increase the degree of coupling, and the antenna elements 4a-3 and 4c do not contact the power supply line 5a via a metal conductor pattern. With this configuration, electric power supplied from the power supply line 5a to the antenna elements 4a-3 and 4c becomes smaller than electric power supplied to the antenna elements 4a-1 and 4a-2.

The antenna elements 4b-1 and 4b-2 physically contact the power supply line 5b via a metal conductor pattern in order to increase the degree of coupling, and the antenna elements 4b-3 and 4c do not contact the power supply line 5b via a metal conductor pattern. With this configuration, electric power supplied from the power supply line 5b to the antenna elements 4b-3 and 4c becomes smaller than electric power supplied to the antenna elements 4b-1 and 4b-2.

As described above, the antenna element 4c is placed away from the power supply lines 5a and 5b and does not physically contact the power supply lines 5a and 5b via a metal conductor pattern. In addition, electric power supplied to the antenna element 4c is smaller than electric power supplied to the antenna elements 4a-1, 4a-2, 4b-1, and 4b-2. With this configuration, for example, when the sub-array antenna 6a is performing an operation for radiating electromagnetic waves, electric power that leaks to the sub-array antenna 6b can be suppressed or reduced. Also, for example, when the sub-array antenna 6b is performing an operation for radiating electromagnetic waves, electric power that leaks to the sub-array antenna 6a can be suppressed or reduced. For example, when the sub-array antenna 6a is performing an operation for radiating electromagnetic waves, the sub-array antenna 6b does not perform an operation for radiating electromagnetic waves.

It is desirable that electric power supplied to the antenna element 4c be adjusted to be smaller than or equal to electric power supplied to the antenna elements 4a-1 to 4a-3 and 4b-1 to 4b-3.

Such adjustment of the electric power to be supplied makes it possible to suppress or reduce electric power that leaks to the sub-array antenna 6b when electric power is supplied to the sub-array antenna 6a. Also, when electric power is supplied to the sub-array antenna 6b, electric power that leaks to the sub-array antenna 6a can be suppressed or reduced.

For example, for the sub-array antennas 6a and 6b each being constituted by four antenna elements, it is desirable that electric power supplied to the antenna element 4c through the power supply line 5a be adjusted to be 20% or less of electric power supplied from the power supply point 7a to the power supply line 5a. It is also desirable that electric power supplied to the antenna element 4c through the power supply line 5b be adjusted to be 20% or less of electric power supplied from the power supply point 7b to the power supply line 5b.

Also, since the sub-array antennas 6a and 6b function as a time-division MIMO antenna, electric powers are supplied from the power supply points 7a and 7b to the antenna element 4c at different timings (in a time-division manner), rather than being supplied therefrom at the same time. Thus, the antenna element 4c operates as an antenna element for the sub-array antenna 6a when electric power is supplied from the power supply point 7a and operates as an antenna element for the sub-array antenna 6b when electric power is supplied from the power supply point 7b.

Next, a description will be given of a radiation characteristic of the antenna device 2 according to the first embodiment.

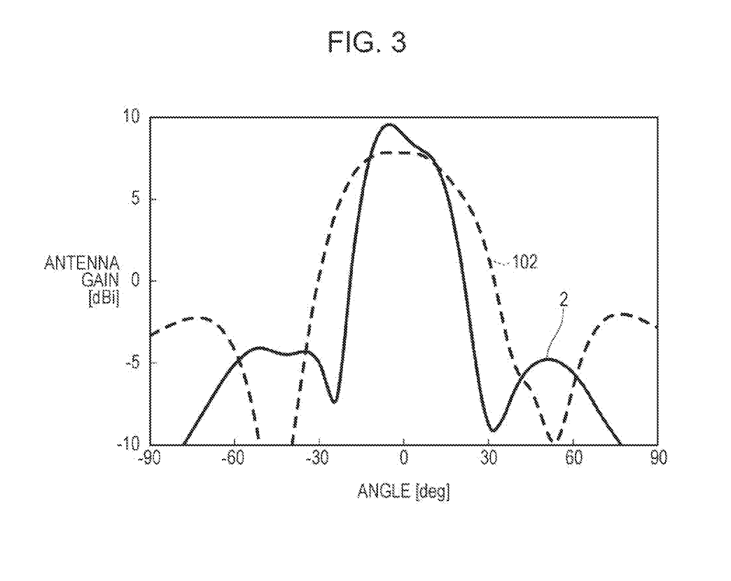

FIG. 3 is a graph illustrating a radiation characteristic of the antenna device 2 according to the first embodiment. FIG. 3 also illustrates, as a comparative example, a radiation characteristic of the antenna device 102 illustrated in FIGS. 1A and 1B. The radiation characteristics illustrated in FIG. 3 are radiation characteristics of 79 gigahertz (GHz) electromagnetic waves radiated in the positive Z-axis direction, the radiation characteristics being determined using electromagnetic field simulation. In FIG. 3, the horizontal axis represents a radiation angle (in degrees [deg]) of electromagnetic waves, and the vertical axis represents an antenna gain (in decibels isotropic [dBi]). In FIG. 3, the radiation angle on the horizontal axis is an angle relative to the Z-axis in a plane parallel to an X-Z plane in FIGS. 1A and 2A, where the Z-axis is assumed to be 0 degree. Also, electric power supplied to the antenna element 4c in the antenna device 2 is adjusted to 12% of electric power supplied to the power supply points 7a and 7b.

As illustrated in FIG. 3, the maximum value of the antenna gain of the antenna device 2 is about 1.8 dB higher than the maximum value of the antenna gain of the antenna device 102. Sidelobes of the antenna device 2 can be reduced by about 2 to 3 dB, compared with the antenna device 102.

In the antenna device 2 according to the first embodiment, the sub-array antennas 6a and 6b share the antenna element 4c to thereby maintain the antenna gap d, thus making it possible to increase the number of antenna elements in each sub-array antenna from two to four. Thus, it is possible to improve the antenna gain (the directional gain), to suppress or reduced unwanted sidelobes, and to improve the antenna performance.

The antenna device 2 is an example in which the antenna elements 4 are arranged in one line along the X-axis. The present disclosure is not limited to this example. Next, a description will be given of an example in which antenna devices are arranged in the Y-axis direction and are connected in parallel.

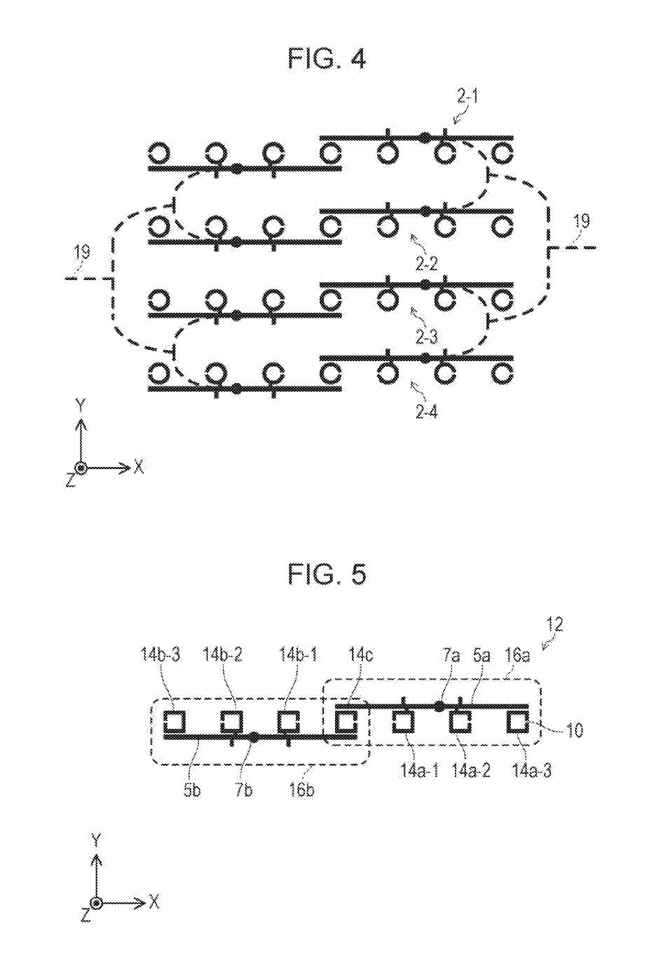

FIG. 4 is a top view illustrating a first modification of the configuration of the antenna device according to the first embodiment. An antenna device illustrated in FIG. 4 has a configuration in which four antenna devices 2 (antenna devices 2-1 to 2-4) are arranged in the Y-axis direction. Electric power is supplied to power supply points 7a and 7b in the antenna devices 2 through back-side wiring lines 19 and power supply vias (not illustrated).

This configuration can improve the antenna gain (the directional gain) in a vertical direction (a Y-axis direction) in addition to the horizontal direction (the X-axis direction), can suppress or reduce unwanted sidelobes, and can improve the antenna performance. This configuration can also reduce not only a half-value angle in the horizontal direction (the X-axis direction) of an electromagnetic-wave main beam that the antenna device radiates in the positive Z-axis direction but also a half-value angle in the vertical direction (the Y-axis direction).

The operating frequency noted above in the first embodiment is one example, and the present disclosure is not limited thereto. The antenna device in the present disclosure may also be operated in a high frequency band of 10 GHz or higher including a millimeter wave band and a terahertz band.

The description in the first embodiment has been given of an example in which the number of sub-array antennas 6 is two. The present disclosure is not limited to the example. The number of sub-array antennas 6 may be three or more. For example, when a third sub-array antenna 6c (not illustrated) is provided on the antenna device 2 in the positive X-axis direction relative to the sub-array antenna 6a, the sub-array antenna 6a and the third sub-array antenna 6c share the antenna element 4a-3.

The above description in the first embodiment has been given of an example in which the number of antenna elements 4 shared by the two sub-array antennas 6 is 1. The present disclosure is not limited to this example. The number of antenna elements 4 shared by the two sub-array antennas 6 may be two or more. For example, when each sub-array antenna 6 is constituted by eight antenna elements 4, and two sub-array antennas 6 share two antenna elements 4, the two sub-array antennas 6 are constituted by 14 antenna elements 4.

Also, the description in the first embodiment has been given of an example in which each antenna element 4 has a looped shape with the notch 10. The present disclosure is not limited to the example. Each antenna element 4 may have a shape, such as a rectangular or quadrangular shape, that is different from the looped shape.

FIG. 5 is a top view illustrating a second modification of the configuration of the antenna device according to the first embodiment. In an antenna device 12 illustrated in FIG. 5, the looped shape antenna elements 4 in the antenna device 2 is replaced with rectangular antenna elements 14 (antenna elements 14a-1 to 14a-3, 14b-1 to 14b-3, and 14c).

In the antenna device 12 illustrated in FIG. 5, sub-array antennas 16a and 16b share the antenna element 14c to thereby maintain an antenna gap as in the antenna device 2, thus making it possible to increase the number of antenna elements in each sub-array antenna from two to four. Thus, it is possible to improve the antenna gain (the directional gain), to suppress or reduce unwanted sidelobes, and to improve the antenna performance.

Although, in the antenna device 12 illustrated in FIG. 5, an example in which the two sub-array antennas 16a and 16b share the antenna element 14c has been described, the present disclosure is not limited thereto. For example, even when three or more sub-array antennas are arranged along the X-axis, and adjacent sub-array antennas of the three or more sub-array antennas share an antenna element, advantages that are analogous to those described above can be obtained.

### SECOND EMBODIMENT

The description in the first embodiment has been given of an example of an antenna device in which antenna elements are arranged on a straight line (one-dimensionally) along each power supply line that extends in one direction (the X-axis direction). In a second embodiment, a description will be given of an example of an antenna device in which antenna elements are arranged in a two-dimensional manner (two-dimensionally).

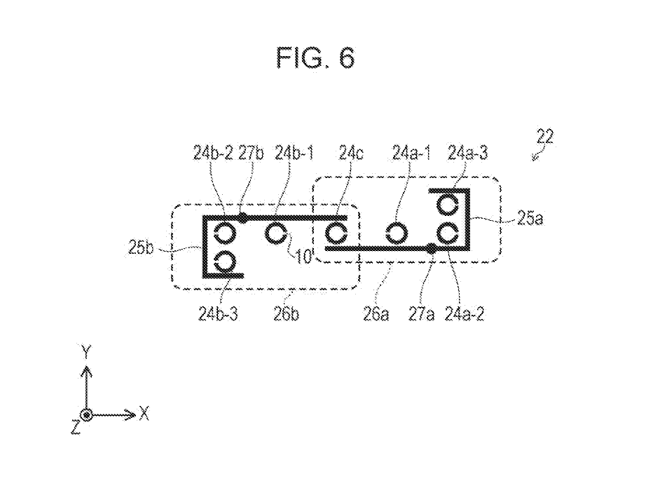

FIG. 6 is a top view illustrating one example of the configuration of an antenna device 22 according to the second embodiment.

In the antenna device 22, the arrangements of some of the antenna elements in the antenna device 2 have been changed. Since power supply vias and back-side wiring lines through which electric power is supplied to the antenna device 22 are the same as or similar to the power supply vias 8 and the back-side wiring lines 9 in the antenna device 2 described above, they are not illustrated. Since a dielectric substrate on which the antenna device 22 is formed and reflectors provided in a layer in the dielectric substrate are also the same as or similar to those in the antenna device 2 described above, they are not illustrated.

The antenna device 22 includes, for example, sub-array antennas 26a and 26b. The sub-array antenna 26a includes antenna elements 24a-1 to 24a-3 and 24c and a power supply line 25a. The sub-array antenna 26b includes antenna elements 24b-1 to 24b-3, the antenna element 24c, and a power supply line 25b. The antenna element 24c is shared by the sub-array antennas 26a and 26b.

In the description below, the antenna elements 24a-1 to 24a-3 may be referred to as “antenna elements 24a”, as appropriate. The antenna elements 24b-1 to 24b-3 may also be referred to as “antenna elements 24b”, as appropriate.

Since the sub-array antennas 26a and 26b function as a time-division MIMO antenna, electric powers are supplied from the power supply points 27a and 27b at different timings (in a time-division manner), rather than being supplied therefrom at the same time.

Each of the antenna elements 24a-1 to 24a-3, 24b-1 to 24b-3, and 24c is a looped-shape element having a notch 10. The orientation of the notch 10 in each of the antenna elements 24a-2, 24a-3, 24b-1, and 24c is the positive X-axis direction. The orientation of the notch 10 in each of the antenna elements 24a-1, 24b-2, and 24b-3 is the negative X-axis direction. The orientations of the notches 10 in the antenna device 22 are merely exemplary, and the present disclosure is not limited thereto. For example, the orientations of the notches 10 may be set according to antenna characteristics.

The antenna elements 24a-1, 24a-2, 24b-1, 24b-2, and 24c are arranged on a straight line along the X-axis direction. The antenna element 24a-3 is arranged in alignment with the antenna element 24a-2 along the Y-axis direction and in the positive Y-axis direction relative to the antenna element 24a-2. The antenna element 24b-3 is arranged in alignment with the antenna element 24b-2 along the Y-axis direction and in the negative Y-axis direction relative to the antenna element 24b-2.

The antenna elements 24a-1 to 24a-3 are arranged along the power supply line 25a. Part of the power supply line 25a which extends in the positive X-axis direction relative to the power supply point 27a is formed so as to bend in the positive Y-axis direction in accordance with the arrangement of the antenna element 24a-3 and so as to lie along the antenna element 24a-3.

The state of connection between each of the antenna elements 24a-1 to 24a-3 and the power supply line 25a and a positional relationship therebetween may also be determined, for example, depending on a system that uses the antenna device 22 in the second embodiment.

As in the first embodiment, electric power to be received by the antenna elements 24a can be adjusted depending on a combination of a positional relationship between the antenna element(s) 24a connected to the power supply line 25a via a metal conductor pattern and the power supply point 27a and a positional relationship between the antenna element(s) 24a that couple(s) with the power supply line 25a via an electromagnetic field and the power supply point 27a.

The antenna elements 24b-1 to 24b-3 are arranged along the power supply line 25b. Part of the power supply line 25b which extends in the negative X-axis direction relative to the power supply point 27b is formed so as to bend in the negative Y-axis direction in accordance with the arrangement of the antenna element 24b-3 and so as to lie along the antenna element 24b-3.

The state of connection between each of the antenna elements 24b-1 to 24b-3 and the power supply line 25b and a positional relationship therebetween may also be determined, for example, depending on a system that uses the antenna device 22 in the second embodiment.

As in the first embodiment, electric power to be received by the antenna elements 24b can be adjusted depending on a combination of a positional relationship between the antenna element(s) 24b connected to the power supply line 25b via a metal conductor pattern and the power supply point 27b and a positional relationship between the antenna element(s) 24b that couple(s) with the power supply line 25b via an electromagnetic field and the power supply point 27b.

The antenna element 24c is arranged, for example, along the power supply lines 25a and 25b and between the antenna elements 24a-1 and 24b-1. The antenna element 24c couples with, for example, the power supply line 25a via an electromagnetic field to receive electric power from the power supply line 25a. The antenna element 24c also couples with, for example, the power supply line 25b via an electromagnetic field to receive electric power from the power supply line 25b. However, the antenna element 24c does not receive electric power from both the power supply lines 25a and 25b at the same timing. The antenna element 24c is not connected to the power supply lines 25a and 25b via a metal conductor pattern. The antenna element 24c is placed away from the power supply lines 25a and 25b.

The sub-array antenna 26a is designed such that electric power supplied from the power supply line 25a to the antenna element 24c is smaller than or equal to electric power supplied to the antenna elements 24a-1, 24a-2, and 24a-3.

The sub-array antennas 26b is also designed such that electric power supplied from the power supply line 25b to the antenna element 24c is smaller than or equal to electric power supplied to the antenna elements 24b-1, 24b-2, and 24b-3.

Thus, the sub-array antennas 26a and 26b operates upon receiving power supplied in a time-division manner, as in the first embodiment, and the antenna element 24c, which is placed away from the power supply lines 25a and 25b, couples therewith via an electromagnetic field, thereby making it possible to suppress or reduce electric power that leaks to the sub-array antenna 26b, for example, when the sub-array antenna 26a is performing an operation for radiating electromagnetic waves. Also, for example, when the sub-array antenna 26b is performing an operation for radiating electromagnetic waves, it is possible to suppress or reduce electric power that leaks to the sub-array antenna 26a.

It is desirable that electric power supplied to the antenna element 24c be adjusted to be smaller than or equal to electric power supplied to the antenna elements 24a-1 to 24a-3 and 24b-1 to 24b-3.

Such adjustment of the electric power to be supplied makes it possible to suppress or reduce electric power that leaks to the sub-array antenna 26b when electric power is supplied to the sub-array antenna 26a. Also, when electric power is supplied to the sub-array antenna 26b, electric power that leaks to the sub-array antenna 26a can be suppressed or reduced.

Also, as in the first embodiment, since the sub-array antennas 26a and 26b function as a time-division MIMO antenna, electric powers are supplied from the power supply points 27a and 27b to the antenna element 24c at different timings (in a time-division manner), rather than being supplied therefrom at the same time. Thus, the antenna element 24c operates as an antenna element for the sub-array antenna 26a when electric power is supplied from the power supply point 27a and operates as an antenna element for the sub-array antenna 26b when electric power is supplied from the power supply point 27b.

In the antenna device 22 according to the second embodiment, the sub-array antennas 26a and 26b share the antenna element 24c to thereby maintain the antenna gap, thus making it possible to increase the number of antenna elements in each sub-array antenna. Thus, it is possible to improve the antenna gain (the directional gain), to suppress or reduce unwanted sidelobes, and to improve the antenna performance.

In the antenna device 22 according to the second embodiment, the antenna elements 24a-1, 24a-2, 24b-1, 24b-2, and 24c are arranged in the horizontal direction (the X-axis direction), and the antenna elements 24a-3 and 24b-3 are arranged in a direction orthogonal (i.e., the Y-axis direction) to the antenna elements arranged in the horizontal direction. This configuration makes it possible to reduce not only a half-value angle in the horizontal direction (the X-axis direction) of an electromagnetic-wave main beam that the antenna device 22 radiates in the positive Z-axis direction but also a half-value angle in the vertical direction (the Y-axis direction).

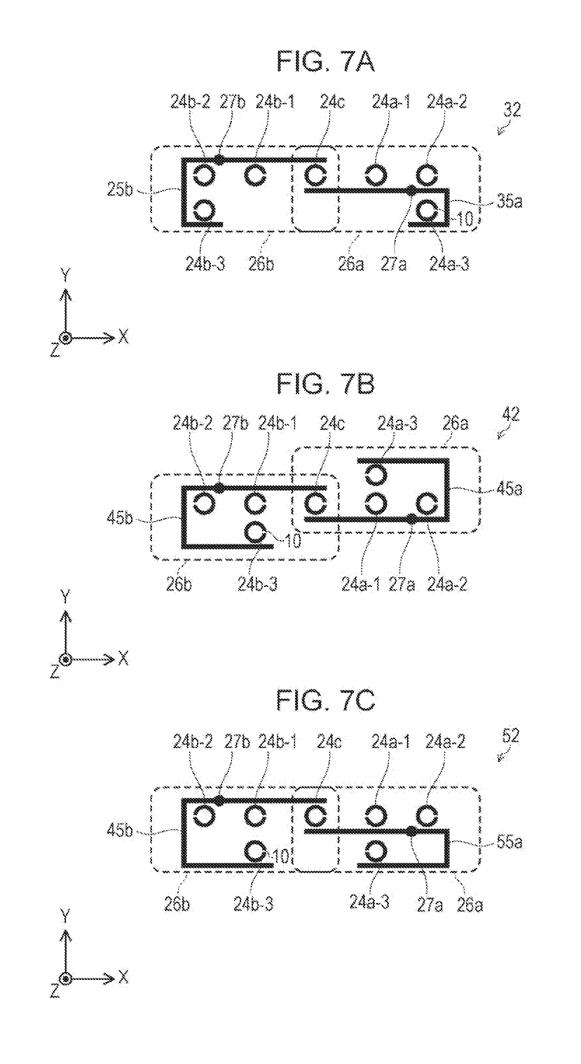

FIG. 6 illustrates one example of an antenna device in which antenna elements are arranged in a two-dimensional manner (two-dimensionally), and the present disclosure is not limited thereto. A modification of the antenna device in which antenna elements are arranged in a two-dimensional manner (two-dimensionally) will be described next with reference to FIGS. 7A to 7C.

FIG. 7A is a top view illustrating a first modification of the antenna device according to the second embodiment. FIG. 7B is a top view illustrating a second modification of the antenna device according to the second embodiment. FIG. 7C is a top view illustrating a third modification of the antenna device according to the second embodiment. In FIGS. 7A to 7C, constituent elements that are the same as or similar to those in FIG. 6 are denoted by the same reference numerals, and descriptions thereof are not given hereinafter.

An antenna device 32 illustrated in FIG. 7A differs in the position of the antenna element 24a-3 from the antenna device 22 illustrated in FIG. 6.

The antenna element 24a-3 in the antenna device 32 is arranged in alignment with the antenna element 24a-2 along the Y-axis direction and in the negative Y-axis direction relative to the antenna element 24a-2. Part of a power supply line 35a which extends in the positive X-axis direction relative to the power supply point 27a is formed so as to bend in the negative Y-axis direction in accordance with the arrangement of the antenna element 24a-3 and so as to lie along the antenna element 24a-3.

An antenna device 42 illustrated in FIG. 7B differs in the positions of the antenna elements 24a-3 and 24b-3 from the antenna device 22 in FIG. 6.

The antenna element 24a-3 in the antenna device 42 is arranged in alignment with the antenna element 24a-1 along the Y-axis direction and in the positive Y-axis direction relative to the antenna element 24a-1. Part of a power supply line 45a which extends in the positive X-axis direction relative to the power supply point 27a is formed so as to bend in the positive Y-axis direction in accordance with the arrangement of the antenna element 24a-3 and so as to lie along the antenna element 24a-3.

The antenna element 24b-3 in the antenna device 42 is arranged in alignment with the antenna element 24b-1 along the Y-axis direction and in the negative Y-axis direction relative to the antenna element 24b-1. Part of a power supply line 45b which extends in the negative X-axis direction relative to the power supply point 27b is formed so as to bend in the negative Y-axis direction in accordance with the arrangement of the antenna element 24b-3 and so as to lie along the antenna element 24b-3.

The notch 10 of the antenna element 24a-3 is provided in the negative X-axis direction. The notch 10 of the antenna element 24b-3 is provided in the positive X-axis direction.

An antenna device 52 illustrated in FIG. 7C in the position of the antenna element 24a-3 differs from the antenna device 42 illustrated in FIG. 7B.

The antenna element 24a-3 in the antenna device 52 is arranged in alignment with the antenna element 24a-1 along the Y-axis direction and in the negative Y-axis direction relative to the antenna element 24a-1. Part of a power supply line 55a which extends in the positive X-axis direction relative to the power supply point 27a is formed so as to bend in the negative Y-axis direction in accordance with the arrangement of the antenna element 24a-3 and so as to lie along the antenna element 24a-3.

This configuration makes it possible to reduce not only a half-value angle in the horizontal direction (the X-axis direction) of an electromagnetic-wave main beam that the antenna device radiates in the positive Z-axis direction but also a half-value angle in the vertical direction (the Y-axis direction).

The antenna devices illustrated in FIGS. 6 and 7A to 7C form respective beam patterns that are different from each other. For example, in order to obtain a desired beam pattern, an antenna-element planar arrangement can be selected from antenna-element planar arrangements including those in FIGS. 6 and 7A to 7C, as appropriate, based on design conditions of an antenna device.

The orientations of the notches 10 in the antenna elements in the antenna devices illustrated in FIGS. 6 and 7A to 7C are merely exemplary, and the present disclosure is not limited thereto. For example, the orientations of the notches 10 may also be set according to antenna characteristics.

Two or more of the antenna devices described above in the second embodiment may be arranged in the X-axis direction or may be arranged in the Y-axis direction.

### THIRD EMBODIMENT

The description in the first embodiment has been given of an example in which two sub-array antennas share one antenna element. In a third embodiment, a description will be given of an example in which two sub-array antennas share a plurality of antenna elements.

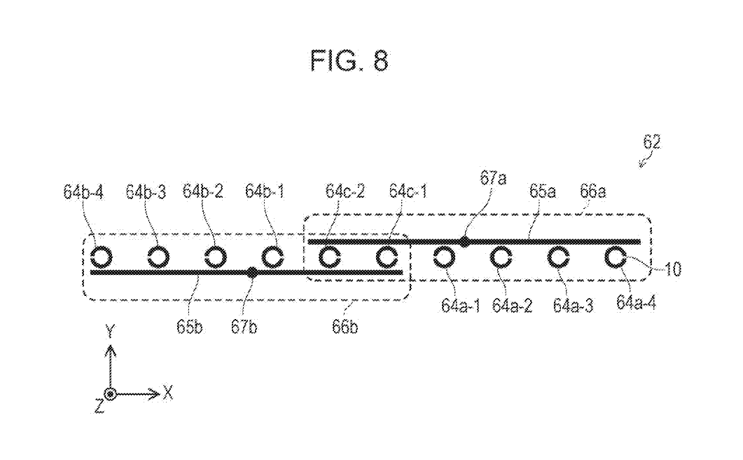

FIG. 8 is a top view illustrating one example of the configuration of an antenna device 62 according to the third embodiment. In FIG. 8, antenna elements are linearly arranged, two sub-array antennas share two antenna elements thereof. Even when the number of antenna elements that are shared is three or more, the antenna elements can be linearly arranged, as in FIG. 8.

In the antenna device 62 illustrated in FIG. 8, since two antenna elements that are shared are provided, it is possible to improve the antenna gain by increasing the number of antenna elements in each sub-array antenna from four to six, while maintaining the gap between the sub-array antennas. In addition, it is possible to improve a working rate of elements in the antenna that operates as a time-division MIMO antenna.

The antenna device 62 includes, for example, sub-array antennas 66a and 66b. The sub-array antenna 66a includes antenna elements 64a-1 to 64a-4, 64c-1, and 64c-2, and a power supply line 65a. The sub-array antenna 66b includes antenna elements 64b-1 to 64b-4, the antenna elements 64c-1 and 64c-2, and a power supply line 65b. The antenna elements 64c-1 and 64c-2 are antenna elements shared by the sub-array antennas 66a and 66b.

In the description below, the antenna elements 64a-1 to 64a-4 may be referred to as “antenna elements 64a”, as appropriate. The antenna elements 64b-1 to 64b-4 may also be referred to as “antenna elements 64b”, as appropriate. The antenna elements 64c-1 and 64c-2 may also be referred to as “antenna elements 64c”, as appropriate.

Since the sub-array antennas 66a and 66b function as a time-division MIMO antenna, electric powers are supplied from the power supply points 67a and 67b at different timings (in a time-division manner), rather than being supplied therefrom at the same time.

The antenna elements 64a-1 to 64a-4, 64b-1 to 64b-4, 64c-1, and 64c-2 are arranged on a straight line along the X-axis direction. The orientations of the notches 10 in the antenna elements in the antenna device 62 are merely exemplary, and the present disclosure is not limited thereto. For example, the orientations of the notches 10 may also be set according to antenna characteristics.

The antenna elements 64a-1 to 64a-4 are arranged along the power supply line 65a. The antenna elements 64b-1 to 64b-4 are arranged along the power supply line 65b.

The state of connection between each of the antenna elements 64a-1 to 64a-4 and the power supply line 65a and a positional relationship therebetween may also be determined, for example, depending on a system that uses the antenna device 62 in the third embodiment.

As in the first embodiment, electric power to be received by the antenna elements 64a can be adjusted depending on a combination of a positional relationship between the antenna element(s) 64a connected to the power supply line 65a via a metal conductor pattern and the power supply point 67a and a positional relationship between the antenna element(s) 64a that couple(s) with the power supply line 65a via an electromagnetic field and the power supply point 67a.

The state of connection between each of the antenna elements 64b-1 to 64b-4 and the power supply line 65b and a positional relationship therebetween may also be determined, for example, depending on a system that uses the antenna device 62 in the third embodiment.

As in the first embodiment, electric power to be received by the antenna elements 64b can be adjusted depending on a combination of a positional relationship between the antenna element(s) 64b connected to the power supply line 65b via a metal conductor pattern and the power supply point 67b and a positional relationship between the antenna element(s) 64b that couple(s) with the power supply line 65b via an electromagnetic field and the power supply point 67b.

The antenna elements 64c are arranged, for example, between the antenna elements 64a-1 and 64b-1 and along the power supply lines 65a and 65b. The antenna elements 64c couple with, for example, the power supply line 65a via an electromagnetic field to receive electric power from the power supply line 65a. The antenna elements 64c also couple with, for example, the power supply line 65b via an electromagnetic field to receive electric power from the power supply line 65b. The antenna elements 64c are not connected to the power supply lines 65a and 65b via a metal conductor pattern. The antenna elements 64c are placed away from the power supply lines 65a and 65b.

The sub-array antenna 66a is designed such that electric power supplied from the antenna elements 64c to the power supply line 65a is smaller than or equal to electric power supplied to the antenna element 64a.

The sub-array antenna 66b is also designed such that electric power supplied from the power supply line 65b to the antenna elements 64c is smaller than or equal to electric power supplied to the antenna element 64b.

Also, as in the first embodiment, since the sub-array antennas 66a and 66b function as a time-division MIMO antenna, electric powers are supplied from the power supply points 67a and 67b to the antenna elements 64c at different timings (in a time-division manner), rather than being supplied therefrom at the same time. Thus, the antenna elements 64c operate as antenna elements for the sub-array antenna 66a when electric power is supplied from the power supply point 67a and operate as antenna elements for the sub-array antenna 66b when electric power is supplied from the power supply point 67b.

In the antenna device 62, the number of antenna elements that are shared may also be increased in the vertical direction (the Y-axis direction), as in FIG. 4. In such a case, even when the number of antenna elements in each sub-array antenna is increased to six in order to improve the antenna gain, the antenna gaps can be reduced more effectively.

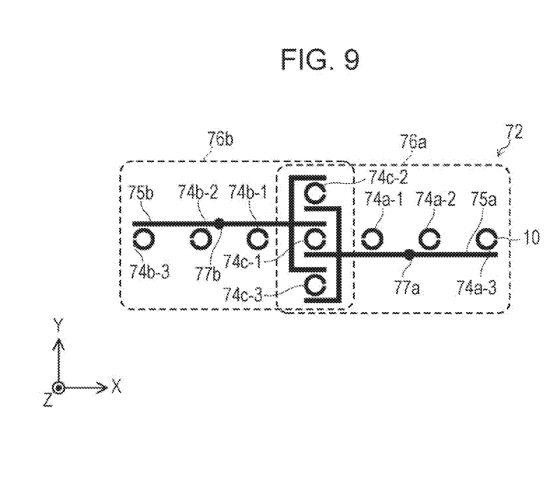

FIG. 9 is a top view illustrating another example of the configuration of the antenna device 62 according to the third embodiment. In FIG. 9, three antenna elements are shared, and the antenna elements that are shared are arranged orthogonal to antenna elements that are not shared. That is, when the number of antenna elements that are shared is an odd number that is larger than or equal to 3, the antenna elements that are shared can be arranged orthogonal to the antenna elements that are not shared, unlike the configurations illustrated in FIGS. 2A and 8.

An antenna device 72 is an example of an antenna device in which the number of antenna elements that are shared by two sub-array antennas is increased to three, with respect to the antenna device 2. Since power supply vias and back-side wiring lines through which electric power is supplied to the antenna device 72 are the same as or similar to the power supply vias 8 and the back-side wiring lines 9 in the antenna device 2, descriptions thereof are not given hereinafter. Since a dielectric substrate on which the antenna device 72 is formed and reflectors provided in a layer in the dielectric substrate are also the same as or similar to those in the antenna device 2 described above, they are not illustrated.

The antenna device 72 includes, for example, sub-array antennas 76a and 76b. The sub-array antenna 76a includes antenna elements 74a-1 to 74a-3 and 74c-1 to 74c-3 and a power supply line 75a. The sub-array antenna 76b includes antenna elements 74b-1 to 74b-3, the antenna elements 74c-1 to 74c-3, and a power supply line 75b. The antenna elements 74c-1 to 74c-3 are shared by the sub-array antennas 76a and 76b.

Since the sub-array antennas 76a and 76b function as a time-division MIMO antenna, electric powers are supplied from the power supply points 77a and 77b at different timings (in a time-division manner), rather than being supplied therefrom at the same time.

Each antenna element is a looped-shape element having a notch 10. The orientation of the notch 10 in each of the antenna elements 74a-2, 74a-3, 74b-1, and 74c-1 to 74c-3 is the positive X-axis direction. The orientation of the notch 10 in each of the antenna elements 74a-1, 74b-2, and 74b-3 is the negative X-axis direction. The orientations of the notches 10 in the antenna device 72 are merely exemplary, and the present disclosure is not limited thereto. For example, the orientations of the notches 10 may also be set according to antenna characteristics.

The antenna elements 74a-1 to 74a-3, 74b-1 to 74b-3, and 74c-1 are arranged on a straight line along the X-axis direction. The antenna element 74c-2 is arranged in alignment with the antenna element 74c-1 along the Y-axis direction and in the positive Y-axis direction relative to the antenna element 74c-1. The antenna element 74c-3 is arranged in alignment with the antenna element 74c-1 along the Y-axis direction and in the negative Y-axis direction relative to the antenna element 74c-1.

The antenna elements 74a-1 to 74a-3 are arranged along the power supply line 75a. The power supply line 75a branches between the antenna elements 74a-1 and 74c-1. The branched portions of the power supply line 75a are formed so as to lie along the antenna elements 74c-2 and 74c-3 in accordance with the arrangements of the antenna elements 74c-2 and 74c-3.

The state of connection between each of the antenna elements 74a-1 to 74a-3 and the power supply line 75a and a positional relationship therebetween may also be determined, for example, depending on a system that uses the antenna device 72 in the third embodiment.

As in the first embodiment, electric power to be received by the antenna elements 74a can be adjusted depending on a combination of a positional relationship between the antenna element(s) 74a connected to the power supply line 75a via a metal conductor pattern and the power supply point 77a and a positional relationship between the antenna element(s) 74a that couple(s) with the power supply line 75a via an electromagnetic field and the power supply point 77a.

The antenna elements 74b-1 to 74b-3 are arranged along the power supply line 75b. A portion of the power supply line 75b branches between the antenna elements 74b-1 and 74c-1. The branched portions of the power supply line 75b are formed so as to lie along the antenna elements 74c-2 and 74c-3 in accordance with the arrangements of the antenna elements 74c-2 and 74c-3.

The state of connection between each of the antenna elements 74b-1 to 74b-3 and the power supply line 75a and a positional relationship therebetween may also be determined, for example, depending on a system that uses the antenna device 72 in the third embodiment.

As in the first embodiment, electric power to be received by the antenna elements 74b can be adjusted depending on a combination of a positional relationship between the antenna element(s) 74b connected to the power supply line 75b via a metal conductor pattern and the power supply point 77b and a positional relationship between the antenna element(s) 74b that couple(s) with the power supply line 75b via an electromagnetic field and the power supply point 77b.

The antenna elements 74c-1 to 74c-3 are arranged, for example, between the antenna elements 74a-1 and 74b-1 and along the power supply lines 75a and 75b. The antenna elements 74c-1 to 74c-3 couple with, for example, the power supply line 75a via an electromagnetic field to receive electric power from the power supply line 75a. The antenna elements 74c-1 to 74c-3 couple with, for example, the power supply line 75b via an electromagnetic field to receive electric power from the power supply line 75b. However, the antenna elements 74c-1 to 74c-3 do not receive electric power from both the power supply lines 75a and 75b at the same timing. The antenna elements 74c-1 to 74c-3 are not connected to the power supply lines 75a and 75b via a metal conductor pattern. The antenna elements 74c-1 to 74c-3 are placed away from the power supply lines 75a and 75b.

The sub-array antenna 76a is designed such that electric power supplied from the power supply line 75a to the antenna elements 74c-1 to 74c-3 is smaller than or equal to electric power supplied to the antenna elements 74a-1 and 74a-2.

Since the electric power is distributed at the antenna elements 74c-1 to 74c-3, the electric power supplied from the power supply line 75a to the antenna elements 74c-1 to 74c-3 becomes smaller than electric power supplied to the antenna element 74a-3.

The sub-array antenna 76b is also designed such that electric power supplied from the power supply line 75b to the antenna elements 74c-1 to 74c-3 is smaller than or equal to the electric power supplied to the antenna elements 74b-1 and 74b-2.

Also, since the electric power is distributed at the antenna elements 74c-1 to 74c-3, the electric power supplied from the power supply line 75b to the antenna elements 74c-1 to 74c-3 becomes smaller than the electric power supplied to the antenna element 74b-3.

As described above, the antenna elements 74c-1 to 74c-3 are placed away from the power supply lines 75a and 75b and do not physically contact the power supply lines 75a and 75b via a metal conductor pattern. In addition, the electric power supplied to the antenna elements 74c-1 to 74c-3 are smaller than the electric power supplied to the antenna elements 74a-1 to 74a-3 and 74b-1 to 74b-3. With this configuration, when the sub-array antenna 76a is performing, for example, an operation for radiating electromagnetic waves, it is possible to suppress or reduce electric power that leaks to the sub-array antenna 76b. Also, when the sub-array antenna 76b is performing, for example, an operation for radiating electromagnetic waves, it is possible to suppress or reduce electric power that leaks to the sub-array antenna 76a. When the sub-array antenna 76a performs, for example, an operation for radiating electromagnetic waves, the sub-array antenna 76b does not perform the operation for radiating electromagnetic waves.

It is desirable that electric power supplied to the antenna elements 74c-1 to 74c-3 be adjusted so as to be smaller than electric power supplied to the antenna elements 74a-1 to 74a-3 and 74b-1 to 74b-3.

Such adjustment of the electric power to be supplied makes it possible to suppress or reduce electric power that leaks to the sub-array antenna 76b when electric power is supplied to the sub-array antenna 76a. Also, when electric power is supplied to the sub-array antenna 76b, electric power that leaks to the sub-array antenna 76a can be suppressed or reduced.

Also, since the sub-array antennas 76a and 76b function as a time-division MIMO antenna, electric powers are supplied from the power supply points 77a and 77b to the antenna elements 74c-1 to 74c-3 at different timings (in a time-division manner), rather than being supplied therefrom at the same time. Thus, the antenna elements 74c-1 to 74c-3 operate as antenna elements for the sub-array antenna 76a when electric power is supplied from the power supply point 77a and operate as antenna elements for the sub-array antenna 76b when electric power is supplied from the power supply point 77b.

As described above, in the antenna device 62 according to the third embodiment, the sub-array antennas 66a and 66b share the antenna elements 64c-1 to 64c-3. Also, in the antenna device 72, the sub-array antennas 76a and 76b share the antenna elements 74c-1 and 74c-2. A plurality of sub-array antennas shares some of the antenna elements to thereby maintain the antenna gap, thus making it possible to increase the number of antenna elements in each sub-array antenna. Thus, it is possible to improve the antenna gain (the directional gain), to suppress or reduce unwanted sidelobes, and to improve the antenna performance.

Also, in the antenna device 62 according to the third embodiment, the antenna elements 64c-1 to 64c-3 are arranged in the vertical direction (the Y-axis direction). This configuration makes it possible to reduce not only a half-value angle in the horizontal direction (the X-axis direction) of an electromagnetic-wave main beam that the antenna device 62 radiates in the positive Z-axis direction but also a half-value angle in the vertical direction (the Y-axis direction).

Although examples in which two sub-array antennas share two and three antenna elements have been described above in the third embodiment, the present disclosure is not limited thereto. For example, even when three or more sub-array antennas are arranged along the X-axis, and adjacent sub-array antennas of the three or more sub-array antennas share the antenna elements, advantages that are analogous to those described above can be obtained.

Also, since the antenna device 72 according to the third embodiment has the plurality of antenna elements (the antenna elements 74c-1 to 74c-3) shared by two sub-array antennas, the degree of freedom of adjusting electric power supplied to the antenna elements that are shared increases. Thus, it is possible to perform more flexible design of an antenna device.

In the embodiments described above, the description has been given of examples in which a power supply point is provided at a generally center of each sub-array antenna. The present disclosure is not limited to the examples.

In addition, in the embodiments described above, the description has been given of examples in which power is supplied through back-side wiring lines. The present disclosure is not limited to the examples. For example, power may be supplied through wiring lines on an obverse side of the substrate.

In the embodiments described above, the description has been given of examples in which the number of antenna elements included in one sub-array antenna is four. The present disclosure is not limited to the examples. The number of antenna elements included in one sub-array antenna may be two, three, five, or more.

In the embodiments described above, the description has been given of examples in which the number of sub-array antennas is two. The present disclosure is not limited to the examples. The number of sub-array antennas may be three or more.

Also, two or more of the antenna devices described in each embodiment may be arranged in the X-axis direction or in the Y-axis direction.

In the embodiments described above, the description has been given of examples in which each antenna element has a looped or rectangular shape with a notch. The present disclosure is not limited to the examples. Each antenna element may be a patch antenna. Alternatively, the antenna elements included in each antenna device may include antenna elements having different shapes. For example, of the antenna elements included in each sub-array antenna, each antenna element that is shared by the sub-array antenna and another sub-array antenna may be a patch antenna, and each antenna element other than the antenna element(s) that is (are) shared may be an antenna element having a shape different from the patch antenna(s).

Also, in the embodiments described above, the description has been given of one or more antenna elements shared by a plurality of sub-array antennas. Each antenna element shared by a plurality of sub-array antennas may also be referred to as an “antenna element owned by a plurality of sub-array antennas.

The above-described functional blocks used in the description of the embodiments can typically be realized as a large-scale integration (LSI), which is an integrated circuit. The integrated circuit may control the individual functional blocks used in the description of the embodiments and may have an input and an output. The functional blocks may be individually integrated into single chips or at least one or all of the functional blocks may be integrated into a single chip. Although the functional blocks are implemented in the form of an LSI in this case, they may also be called an integrated circuit (IC), a system LSI, a super LSI, or an ultra LSI depending on a difference in the degree of integration.

The scheme for integrating the functional blocks into an integrated circuit is not limited to a scheme for LSI and may be realized using a dedicated circuit or a general-purpose processor. The functional blocks can also be implemented using a field programmable gate array (FPGA) that can be programmed after manufacture of an LSI or a reconfigurable processor that allows reconfiguration of connections or settings of circuit cells in an LSI.

In addition, when a circuit integration technology that replaces LSI becomes available with the advancement of semiconductor technology or another derivative technology, such a technology may also naturally be used to integrate the functional blocks. For example, biotechnology is applicable.

The present disclosure can also be implemented as a radio communication device or a control method executed by a control device. The present disclosure can also be implemented by a program for causing a computer to realize the control method. In addition, the present disclosure can also be implemented as a recording medium in which such a program is stored in a computer readable state. That is, the present disclosure can be implemented by any category of an apparatus, a device, a method, a program, and a recording medium.

The present disclosure can also be implemented as any types of apparatus, device, and system having communication functions (these are collectively referred to as “communication apparatuses”). Non-limiting examples of the communication apparatuses include phones (such as mobile phones and smartphones), tablet computers, personal computers (PCs, such as laptop, desktop, and notebook PCs), cameras (such as digital still/video cameras), digital players (such as digital audio/video players), wearable devices (such as wearable cameras, smartwatches, and tracking devices), game consoles, digital book readers, telehealth and telemedicine (remote healthcare and medicine prescription) devices, vehicles or transport systems (such as automobiles, airplanes, and ships) with communication functions, and any combination of the above-described various apparatuses.

The communication apparatuses are not limited to portable or movable communication apparatuses and include any types of apparatus, device, and system that are non-portable or fixed. Examples of such communication apparatuses include smart home devices (such as household electrical and electronic equipment, lighting equipment, smart meters, and measurement equipment, and control panels), vending machines, and any “things” that exist on IoT (Internet of Things) networks.

Communication performed by the communication apparatuses include data communication using cellular systems, wireless local-area network (LAN) systems, and communication satellite systems and data communication using a combination of these systems.

The communication apparatuses also include devices, such as controllers and sensors, that are connected or coupled to communication devices (described below in the present disclosure) that execute a communication function. For example, the communication apparatuses include controllers and sensors that generate control signals and/or data signals used by communication devices that execute communication functions of the communication apparatuses.

The communication apparatuses further include infrastructure equipment that performs communication with the above-described various non-limiting apparatuses or that controls the various apparatuses. Examples of the infrastructure equipment include base stations, access points, and any other apparatuses, devices, and systems.

Although some embodiments have been described above with reference to the accompanying drawings, it goes without saying that the present disclosure is not limited to such examples. It is apparent to those skilled in the art that various variations and modifications can be conceived within the scope recited in the claims, and it is to be understood that such variations and modifications also naturally belong to the technical scope of the present disclosure. The constituent elements in the above-described embodiments may also be arbitrarily combined within a scope that does not depart from the spirit of the disclosure.

### <Brief Summary of the Present Disclosure>

An antenna device in the present disclosure includes: a first sub-array antenna provided on a substrate and having a group of first antenna elements, one or more third antenna elements, and a first electrical power line through which electric power is supplied to the group of first antenna elements and the one or more third antenna elements; and a second sub-array antenna provided on the substrate and having a group of second antenna elements, the one or more third antenna elements, and a second electrical power line through which electric power is supplied to the group of second antenna elements and the one or more third antenna elements. The one or more third antenna elements are placed away from the first electrical power line and the second electrical power line.

In the antenna device in the present disclosure, the one or more third antenna elements may couple with the first electrical power line and the second electrical power line via an electromagnetic field.

In the antenna device in the present disclosure, supply of electric power to the first sub-array antenna and supply of electric power to the second sub-array antenna may be performed in a time-division manner.

In the antenna device in the present disclosure a distance between a center of the first sub-array antenna and a center of the second sub-array antenna in a first direction may be smaller than a length of the first sub-array antenna in the first direction and a length of the second sub-array antenna in the first direction.

In the antenna device in the present disclosure, electric power supplied to the one or more third antenna elements through the first electrical power line may be smaller than or equal to electric power supplied to the group of first antenna elements through the first electrical power line; and electric power supplied to the one or more third antenna elements through the second electrical power line may be smaller than or equal to electric power supplied to the group of second antenna elements through the second electrical power line.

In the antenna device in the present disclosure, at least one of the group of first antenna elements and the group of second antenna elements may include antenna elements arranged along the first direction and antenna elements arranged along a second direction orthogonal to the first direction.

In the antenna device in the present disclosure, the first sub-array antenna and the second sub-array antenna may radiate electromagnetic waves in a frequency band higher than or equal to 10 GHz.

In the antenna device in the present disclosure, the number of first sub-array antennas and the number of second sub-array antennas may be each two or more.

The antenna devices according to the present disclosure are preferably applied to radar devices and so on.

What is claimed is:

1. An antenna device comprising:
a first sub-array antenna provided on a substrate and having a group of first antenna elements, one or more third antenna elements, and a first electrical power line through which electric power is supplied to the group of first antenna elements and the one or more third antenna elements; and
a second sub-array antenna provided on the substrate and having a group of second antenna elements, the one or more third antenna elements, and a second electrical power line through which electric power is supplied to the group of second antenna elements and the one or more third antenna elements,
wherein the one or more third antenna elements are placed away from the first electrical power line and the second electrical power line.

2. The antenna device according to claim 1,
wherein the one or more third antenna elements couple with the first electrical power line and the second electrical power line via an electromagnetic field.

3. The antenna device according to claim 1,
wherein supply of electric power to the first sub-array antenna and supply of electric power to the second sub-array antenna are performed in a time-division manner.

4. The antenna device according to claim 1,
wherein a distance between a center of the first sub-array antenna and a center of the second sub-array antenna in a first direction is smaller than a length of the first sub-array antenna in the first direction and a length of the second sub-array antenna in the first direction.

5. The antenna device according to claim 1,
wherein electric power supplied to the one or more third antenna elements through the first electrical power line is smaller than or equal to electric power supplied to the group of first antenna elements through the first electrical power line; and
wherein electric power supplied to the one or more third antenna elements through the second electrical power line is smaller than or equal to electric power supplied to the group of second antenna elements through the second electrical power line.

6. The antenna device according to claim 1,
wherein at least one of the group of first antenna elements and the group of second antenna elements includes antenna elements arranged along the first direction and antenna elements arranged along a second direction orthogonal to the first direction.

7. The antenna device according to claim 1,
wherein the first sub-array antenna and the second sub-array antenna radiate electromagnetic waves in a frequency band higher than or equal to 10 gigahertz.

8. The antenna device according to claim 1,
wherein the number of first sub-array antennas and the number of second sub-array antennas are each two or more.
